(19) United States
(12) Patent Application Publication
(10) Pub. No.: US 2024/0094001 A1
(43) Pub. Date: Mar. 21, 2024

(54) INERTIAL MEASUREMENT DEVICE OF ELECTRIC MOTORCYCLE

(71) Applicant: KWANG YANG MOTOR CO., LTD., KAOHSIUNG CITY (TW)

(72) Inventor: HSIANG HSU, KAOHSIUNG CITY (TW)

(21) Appl. No.: 18/366,667

(22) Filed: Aug. 7, 2023

(30) Foreign Application Priority Data
Sep. 19, 2022 (TW) 111135352

(51) Int. Cl. G01C 21/16; B62J 1/00; B62J 43/16; B62J 45/41; B62K 11/04; B62K 25/28

(52) U.S. Cl. CPC G01C 21/166; B62J 1/00; B62J 43/16; B62J 45/41; B62K 11/04; B62K 25/283; B62K 2204/00

(57) ABSTRACT

Provided is an inertial measurement device of an electric motorcycle. The electric motorcycle includes a vehicle frame unit including a head tube support frame and a secondary frame; a seat cushion arranged on the secondary frame and including an operator's hips seat; a battery box arranged on the vehicle frame unit and located at a front lower side of the seat cushion, a power unit arranged on the battery box, a vehicle body cover unit covering the vehicle frame unit, an inertial measurement unit mounted on the vehicle frame unit. A lower side of the seat cushion, a front side of a vertical imaginary line in a vehicle body up-down direction and passing through a rear end of the operator's hips seat, a bottom edge of the secondary frame, and a rear side of the battery box jointly define a mounting space, in which the inertial measurement unit is mounted.

### TECHNICAL FIELD OF THE INVENTION

The present invention relaters to an inertial measurement unit of an electric motorcycle, and more particularly to an inertial measurement device of an electric motorcycle, which allows an inertial measurement unit (IMU) to be arranged on the electric motorcycle at a location close to a gravity center thereof or at the gravity center so as to ensure operability and detection accuracy of the inertial measurement unit to thereby enhance riding safety of the electric motorcycle.

### DESCRIPTION OF THE PRIOR ART

For vehicles, particularly a two-wheeled vehicle A, in order to improve safety of riding and operating, an inertial measurement unit I is commonly installed on the vehicle body, so that the inertial measurement unit I may notify the rider with information concerning tilting angle and angular momentum of the vehicle in making a turn, in order to enhance the safety of riding and operating the vehicle.

As shown in FIG. 1, in the technical field of installing an inertial measurement unit I on a two-wheeled vehicle A, such as Japanese Patent Document JP2013-136313 A, it is desired to have the inertial measurement unit I better protected when the inertial measurement unit I is installed on the two-wheeled vehicle A, and to ensure detection accuracy of the inertial measurement unit I, in order to enhance the riding safety of the two-wheeled vehicle A.

Thus, it is a challenge of the electric motorcycle manufacturers to provide an inertial measurement device of an electric motorcycle to enhance the riding safety of the electric motorcycle.

### SUMMARY OF THE INVENTION

The primary objective of the present invention is to provide an inertial measurement device of an electric motorcycle, which allows an inertial measurement unit to be arranged on an electric motorcycle at a location close to a gravity center thereof or at the gravity center and also helps reduce impact of foreign objects against the inertial measurement unit to thereby ensure operability and detection accuracy of the inertial measurement unit.

For such an objective, in some embodiments of the present invention, an inertial measurement device of an electric motorcycle is provided, wherein the electric motorcycle at least comprises a vehicle frame unit, a seat cushion arranged on the vehicle frame unit, a battery box arranged on the vehicle frame unit and located at a front lower side of the seat cushion, a power unit arranged on the battery box, a vehicle body cover unit set on and covering a periphery of the vehicle frame unit, an inertial measurement unit mounted on the vehicle frame unit; the vehicle frame unit at least comprises a head tube support frame and a secondary frame; the seat cushion is arranged on the secondary frame, and the seat cushion at least comprises an operator's hips seat; wherein as viewed from a lateral side, a lower side of the seat cushion, a front side of a vertical imaginary line that passes through a rear end of the operator's hips seat and is arranged in a vehicle body up-down direction, a bottom edge of the secondary frame, and a rear side of the battery box jointly define a mounting space, and the inertial measurement unit is mounted in the mounting space.

The efficacy that the present invention may achieve with some embodiments is that the inertial measurement unit is made to mount on the electric motorcycle at a location close to a gravity center thereof or at the gravity center and to reduce impact of foreign object on the inertial measurement unit to thereby ensure operability and detection accuracy of the inertial measurement unit; and also, the lateral vehicle body covers that are set on and covering outer sides of the secondary frame prevent external dust or moisture from contaminating the inertial measurement unit to thereby enhance riding safety of the electric motorcycle.

### BRIEF DESCRIPTION OF THE DRAWINGS

FIG. 1 shows Japanese Patent JP2013-136313 A.

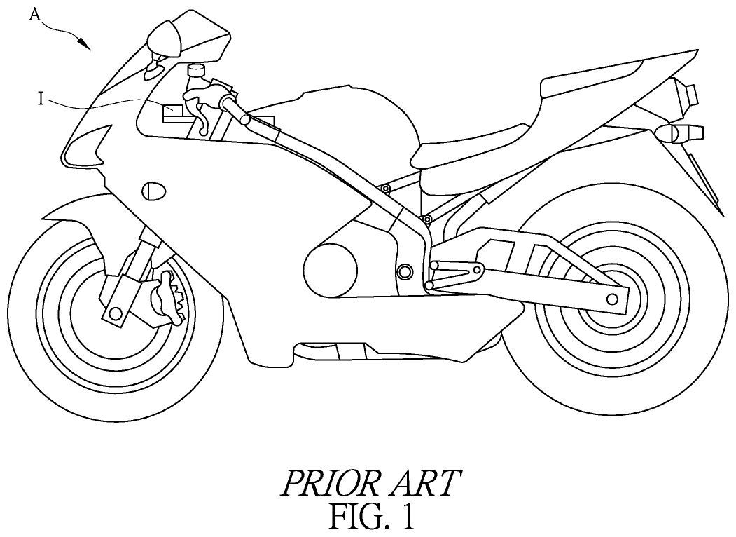

FIG. 2 is a side elevational view showing an electric motorcycle according to the present invention.

FIG. 3 is a front view showing a vehicle frame unit of the electric motorcycle according to the present invention.

FIG. 4 is an enlarged view of a portion of FIG. 2.

FIG. 5 is a schematic view showing an inertial measurement unit mounted on a secondary vehicle frame according to the present invention.

FIG. 6 is a top plan view showing the inertial measurement unit mounted on the secondary vehicle frame according to the present invention.

### DETAILED DESCRIPTION OF THE PREFERRED EMBODIMENT

For better understanding of the structure of the present invention, and the efficacy achieved thereby, a description will be provided below with reference to the drawings:

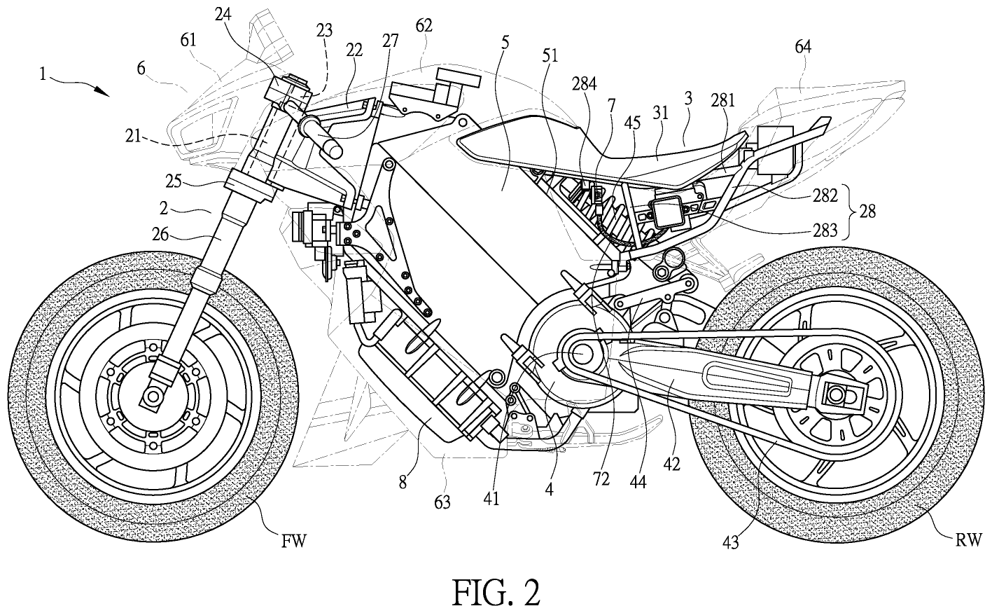

Firstly, referring to FIG. 2, the present invention provides an inertial measurement device of an electric motorcycle. The electric motorcycle 1 at least comprises a vehicle frame unit 2, a seat cushion 3 arranged on the vehicle frame unit 2, a battery box 5 arranged on the vehicle frame unit 2 and located at a front lower side of the seat cushion 3, a power unit 4 arranged on the battery box 5, a vehicle body cover unit 6 set on and covering a periphery of the vehicle frame unit 2, and an inertial measurement unit 7 mounted on the vehicle frame unit 2.

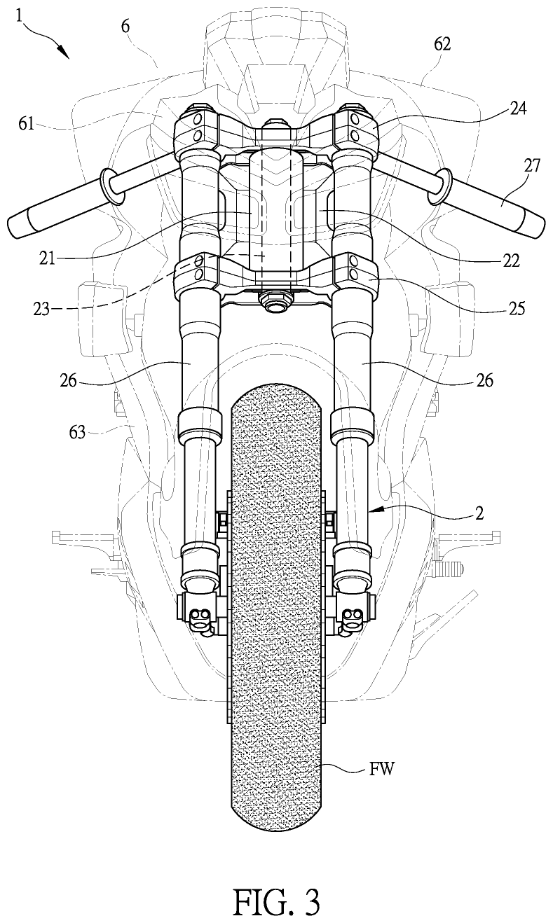

As shown in FIGS. 2 and 3, a head tube portion 21 is arranged at a front of the vehicle frame unit 2, and the head tube portion 21 is provided, in a direction toward a vehicle body rear side, with a head tube support frame 22. A steering column 23 is arranged in and extends through the head tube portion 21, and the steering column 23 is connected, at an upper part thereof, with an upper connection plate 24, and the steering column 23 is connected, at a lower part thereof, with a lower connection plate 25. A front fork unit 26 is arranged to extend between the upper connection plate 24 and the lower connection plate 25. A front wheel FW is rotatably mounted to a lower part of the front fork unit 26. The front fork unit 26 is provided, at a location adjacent to the upper connection plate 24, with steering handgrips 27 that are arranged pairwise as a left one and a right one. As such, operating the steering handgrips 27 may drive the front fork unit 26 to rotate the front wheel FW about a rotation center defined by the steering column 23.

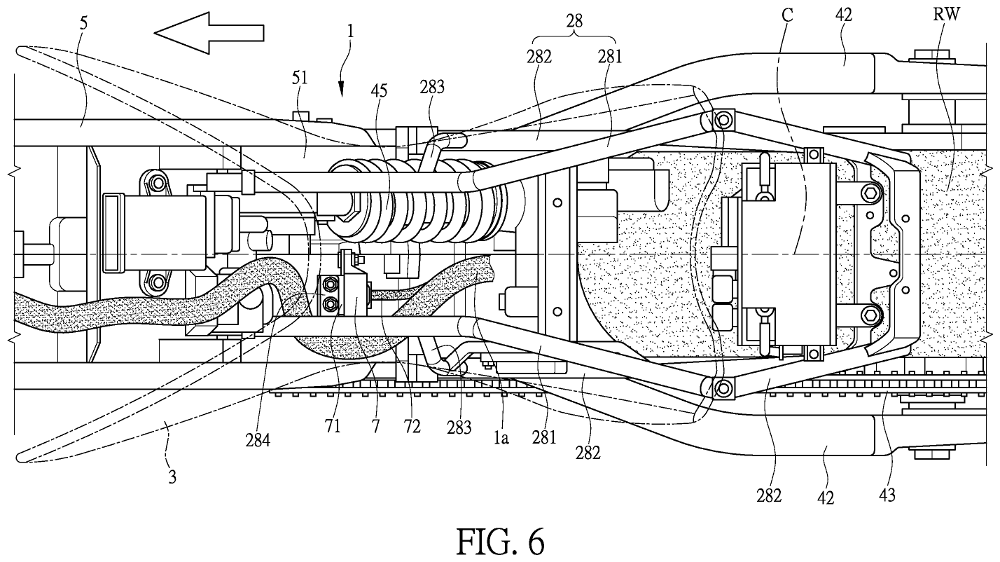

As shown in FIGS. 2, 4, and 6, the head tube support frame 22 is provided, in a direction the vehicle body rear side, with a battery box 5, which is arranged to receive and hold a battery to supply electric power to a motor, fastened thereto, and specifically, the battery box 5 is fastened to the head tube support frame 22 in a manner of being inclined toward the vehicle body rear side, and the battery box 5 includes an inclined surface 51 that inclines downward in a direction toward the vehicle body rear side. The battery box 5 is further connected, in a direction toward the vehicle body rear side, with a secondary frame 28, and in other words, the secondary frame 28 is fastened to the inclined surface 51 of the battery box 5. The vehicle frame unit 2 is formed of the head tube portion 21, the head tube support frame 22, the battery box 5, and the secondary frame 28, and in other words, the battery box 5 also forms a part of the entirety of the vehicle frame unit 2. The secondary frame 28 comprises upper braces 281 that are arranged pairwise as a left one and a right one and are located an upper side and lower braces 282 that are arranged pairwise as a left one and a right one and located at a lower side, and a connection brace portions 283 connected between the upper braces 281 and the lower braces 282. Front ends of the upper braces 281 and the lower braces 282 that face in a direction toward a vehicle body front side are fastened to the battery box 5. The seat cushion 3 is arranged on the secondary frame 28, and specifically, the seat cushion 3 is arranged on the upper braces 281 of the secondary frame 28. The seat cushion 3 at least comprises an operator's hips seat 31 that receives an operator's hips to sit thereon.

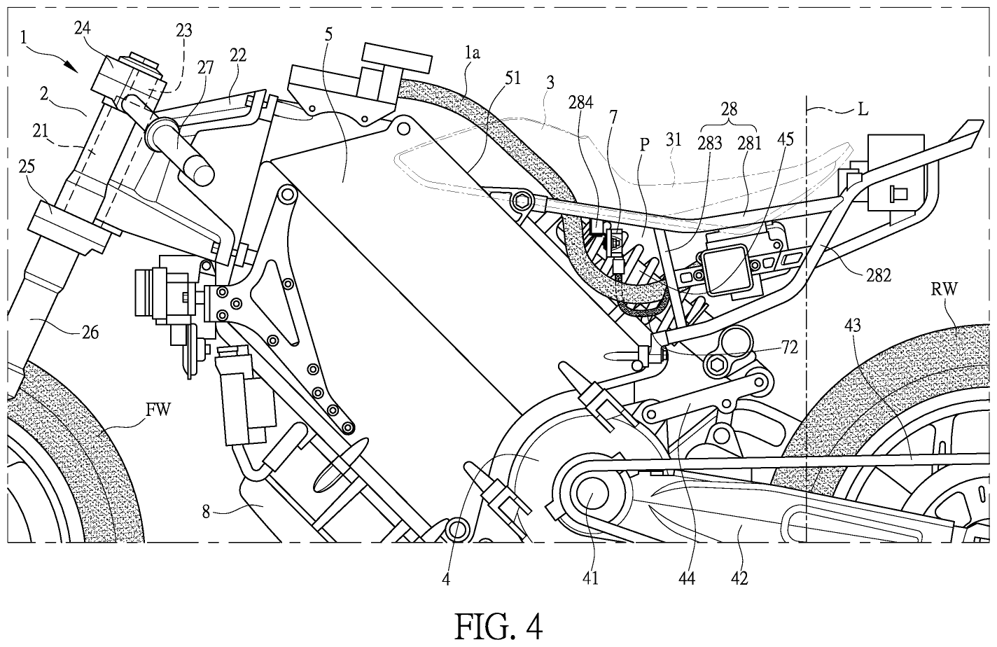

As shown in FIGS. 2 and 4, the battery box 5 is provided, toward a front lower side of the vehicle body, with a controller unit 8 arranged thereon, and the battery box 5 is provided, toward a rear lower side of the vehicle body, with a power unit 4 arranged thereon. In the present invention, the power unit 4 is embodied as an electric motor. The controller unit 8 controls the power unit 4. A rear swingarm 42 is rotatably mounted outside a power output shaft 41 of the power unit 4. A rear wheel RW is rotatably mounted at a rear side of the rear swingarm 42. The power output shaft 41 of the power unit 4 drives, by means of a driving member 43, the rear wheel RW to rotate, so as to cause the electric motorcycle 1 to advance. The driving member 43 can be embodied as a belt or a chain. A connecting frame 44 that is allowed to oscillate is arranged between the power unit 4 and the rear swingarm 42. A rear shock absorber 45 is pivotally mounted to the connecting frame 44, and an opposite end of the rear shock absorber 45 is connected to the secondary frame 28 or the battery box 5.

As shown in FIGS. 2 and 3, the vehicle body cover unit 6 comprises a vehicle head cover 61 set on and covering a front end of the vehicle body, a top vehicle body cover 62 set on and covering a top of the vehicle body and a front part of the seat cushion 3, lateral vehicle body covers 63 set on and covering two lateral sides of the vehicle body, and a rear vehicle body cover 64 set on and covering a rear part of the vehicle body rear side and located at a rear side of the seat cushion 3.

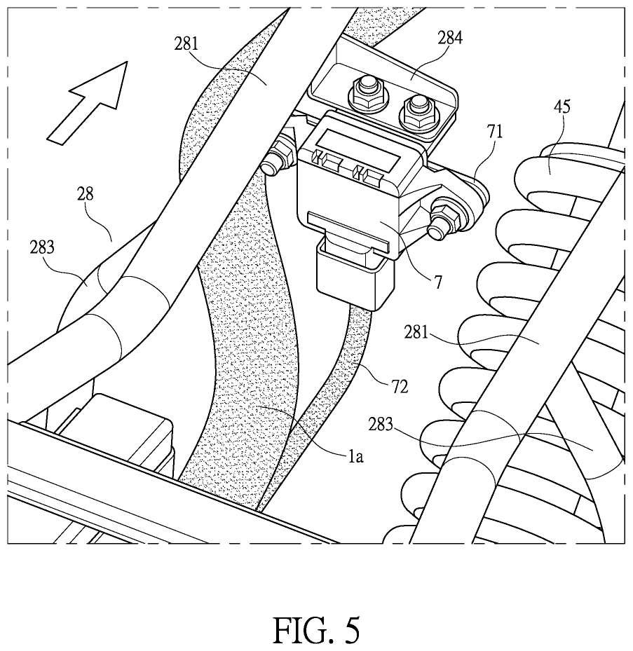

As shown in FIGS. 2, 4, 5, and 6, a connecting base 284 is arranged on the upper braces 281 of the secondary frame 28, and the inertial measurement unit 7 is fastened to the connecting base 284. The inertial measurement unit 7 is fastened by a connecting member 71 to the connecting base 284, and when viewed from the top, the inertial measurement unit 7 is located inboard of outer edges of the upper braces 281 of the secondary frame 28, and in other words, the inertial measurement unit 7 is arranged in a receiving space defined by the upper braces 281 and the lower braces 282 of the secondary frame 28, and when viewed from a lateral side of the vehicle body, the inertial measurement unit 7 and the rear shock absorber 45 are set in a condition of at least partly overlapping each other, and when viewed from the top, the inertial measurement unit 7 and the rear shock absorber 45 are respectively located at two opposite sides of a vehicle body front-rear direction center line C of the electric motorcycle 1, and as such, portions of the inertial measurement unit 7 that are respectively located at left and right sides of the vehicle body are surrounded and protected by the secondary frame 28. A signal output cable 72 of the inertial measurement unit 7 is arranged to extend downward, in a manner of being perpendicular to the connecting member 71, to connect to a main cable 1a of the electric motorcycle 1. The main cable 1a is extended downward along the inclined surface 51 of the battery box 5 to connect to the signal output cable 72 of the inertial measurement unit 7. More specifically, when viewed from a lateral side, the inertial measurement unit 7 is arranged in a mounting space P that is defined by a lower side of the seat cushion 3, a front side of a vertical imaginary line L that passes through a rear end of the operator's hips seat 31 and is arranged in a vehicle body up-down direction, an upper side of a bottom edge of the secondary frame 28, and a rear side of the inclined surface 51 of the battery box 5, so as to have the inertial measurement unit 7 mounted at a location close to a gravity center of the electric motorcycle 1 to thereby ensure the detection accuracy of the inertial measurement unit 7. Since the inertial measurement unit 7 is mounted in the mounting space P, portions of the inertial measurement unit 7 that are on the two sides of the vehicle body are shielded by the lateral vehicle body covers 63 of the vehicle body cover unit 6, and a front side of the inertial measurement unit 7 is shielded by the battery box 5, and a top side of the inertial measurement unit 7 is shielded by the seat cushion 3, so that external foreign objects contaminating or colliding the inertial measurement unit 7 can be reduced. It is noted that if the electric motorcycle 1 tips down, the inertial measurement unit 7 is protected by the secondary frame 28 from being damaged. Further, the inertial measurement unit 7 is located under the seat cushion 3, and when the inertial measurement unit 7 is calibrated or serviced, it only needs to lift open the seat cushion 3 to allow the operation of calibration or servicing to be carried out.

The primary efficacy of the present invention is that an electric motorcycle 1 at least comprises a vehicle frame unit 2, a seat cushion 3 and a power unit 4 arranged on the vehicle frame unit 2, a battery box 5 arranged on the vehicle frame unit 2 and located at a front lower side of the seat cushion 3, a vehicle body cover unit 6 set on and covering a periphery of the vehicle frame unit 2, and an inertial measurement unit 7 mounted on the vehicle frame unit 2; the vehicle frame unit 2 at least comprises a head tube portion 21, a head tube support frame 22, and a secondary frame 28; the battery box comprises an inclined surface 51; the seat cushion 3 is arranged on the secondary frame 28, and the seat cushion 3 at least comprises an operator's hips seat 31; wherein, as viewed from a lateral side, a lower side of the seat cushion 3, a front side of a vertical imaginary line L that passes through a rear end of the operator's hips seat 31 and is arranged in a vehicle body up-down direction, a bottom edge of the secondary frame 28, and a rear side of the battery box 5 jointly define a mounting space P, and the inertial measurement unit 7 is mounted in the mounting space P; as such, the inertial measurement unit 7 is made to mount on the electric motorcycle 1 at a location close to a gravity center thereof or at the gravity center to thereby enhance riding safety of the electric motorcycle 1 and also to provide the inertial measurement unit 7 with bettered protection and to enhance easiness of servicing of the inertial measurement unit 7.

In summary, the above structure that is provided according to the present invention alleviates the drawbacks of the prior art and achieves the desired purpose, and surely achieves an efficacy that improves over the prior art, and thus meets the stipulated requirements of novelty, inventiveness, and utilization for a patent. As such, an application for a patent is filed and granting of such a patent is earnestly solicited.

I claim:

1. An electric motorcycle of an inertial measurement device, wherein the electric motorcycle at least comprises a vehicle frame unit, a seat cushion arranged on the vehicle frame unit, a battery box arranged on the vehicle frame unit and located at a front lower side of the seat cushion, a power unit arranged on the battery box, a vehicle body cover unit set on and covering a periphery of the vehicle frame unit, an inertial measurement unit mounted on the vehicle frame unit; the vehicle frame unit at least comprises a head tube support frame and a secondary frame; the seat cushion is arranged on the secondary frame, and the seat cushion at least comprises an operator's hips seat; wherein as viewed from a lateral side, a lower side of the seat cushion, a front side of a vertical imaginary line that passes through a rear end of the operator's hips seat and is arranged in a vehicle body up-down direction, a bottom edge of the secondary frame, and a rear side of the battery box jointly define a mounting space, and the inertial measurement unit is mounted in the mounting space.

2. The inertial measurement device of the electric motorcycle according to claim 1, wherein the vehicle frame unit is formed of a head tube portion, the head tube support frame, the battery box, and the secondary frame.

3. The inertial measurement device of the electric motorcycle according to claim 1, wherein the secondary frame comprises upper braces and the lower braces; and the upper braces and the lower braces define a receiving space, and the inertial measurement unit is mounted in the receiving space.

4. The inertial measurement device of the electric motorcycle according to claim 1, wherein the power unit is arranged at a lower side of the battery box; a connecting frame that is oscillating is arranged between the power unit and a rear swingarm, and a rear shock absorber is pivotally connected to the connecting frame; and when viewed from a lateral side of a vehicle body, at least a portion of the inertial measurement unit overlaps the rear shock absorber.

5. The inertial measurement device of the electric motorcycle according to claim 1, wherein the battery box comprises an inclined surface; and the mounting space is located at a rear side of the inclined surface.

6. The inertial measurement device of the electric motorcycle according to claim 3, wherein the upper braces are provided with a connecting base; and the inertial measurement unit is fastened by a connecting member to the connecting base.

7. The inertial measurement device of the electric motorcycle according to claim 5, wherein the upper braces are provided with a connecting base; and the inertial measurement unit is fastened by a connecting member to the connecting base.

8. The inertial measurement device of the electric motorcycle according to claim 1, wherein the secondary frame comprises upper braces and lower braces, and the upper braces are provided with a connecting base; the inertial measurement unit comprises a signal output cable, and the signal output cable is extended downward in a manner of being perpendicular to the connecting base; the electric motorcycle comprises a main cable; the battery box comprises an inclined surface; the main cable is arranged to extend along the inclined surface of the battery box to connect to the signal output cable of the inertial measurement unit.

9. The inertial measurement device of the electric motorcycle according to claim 3, wherein when viewed from top, the inertial measurement unit is located inboard of outer edges of the upper braces of the secondary frame.

10. The inertial measurement device of the electric motorcycle according to claim 8, wherein when viewed from top, the inertial measurement unit is located inboard of outer edges of the upper braces of the secondary frame.

11. The inertial measurement device of the electric motorcycle according to claim 4, wherein when viewed from top, the inertial measurement unit and the rear shock absorber are respectively located at two opposite sides of a vehicle body front-rear direction center line.

12. The inertial measurement device of the electric motorcycle according to claim 1, wherein the battery box comprises an inclined surface, a front side of the battery box being fastened to the head tube support frame, the secondary frame being fastened to the inclined surface of the battery box.
